(19) United States
(12) Patent Application Publication
(10) Pub. No.: US 2022/0146237 A1
(43) Pub. Date: May 12, 2022

(54) Target For Shooting Sports With 3D Visual Effect

(71) Applicant: Strike Industries, Inc., Santa Ana, CA (US)

(72) Inventor: Shanyao Lee, Santa Ana, CA (US)

(21) Appl. No.: 17/091,846

(22) Filed: Nov. 6, 2020

(51) Int. Cl. F41J 1/00; G02B 30/23

(52) U.S. Cl. CPC F41J 1/00; G02B 30/23

(57) ABSTRACT

Various examples of a target for shooting sports with three-dimensional (3D) visual effect are described. In one example, a carrier has a surface on which a background object and a target object are displayed. The background object is depicted in two colors such that, when viewed through a pair of color-coded anaglyph glasses by a user with both eyes, the background object appears to be 3D to the user. The target object is depicted in at least a dark color. In another example, a carrier has a surface on which a background object and a target object are displayed. The target object is depicted in two colors such that, when viewed through a pair of color-coded anaglyph glasses by a user with both eyes, the target object appears to be 3D to the user. The background object is depicted in at least a dark color.

### TECHNICAL FIELD

The present disclosure is generally related to targets for shooting sports and, more particularly, to a target for shooting sports with three-dimensional (3D) visual effect.

### BACKGROUND

Unless otherwise indicated herein, approaches described in this section are not prior art to the claims listed below and are not admitted as prior art by inclusion in this section.

Shooting targets are objects in various forms and shapes that are used for pistol, rifle, shotgun, air gun, BB gun, airsoft gun, archery, crossbow and other shooting sports, whether firearms or non-firearms are involved. A center portion of a target is referred to as the bullseye. In some cases the bullseye is in the form of a circle surrounded by concentric circles. In other cases an image or a shape resembling an object or person is used with a portion thereof representing the bullseye. Traditional targets are typically made of paper, steel plate or rubber.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a carrier has a surface on which a background object and a target object are displayed. The background object is depicted in two colors such that, when viewed through a pair of color-coded anaglyph glasses by a user with both eyes, the background object appears to be 3D to the user. The target object is depicted in at least a dark color which is darker than the two colors used in depicting the background object.

In another aspect, a carrier has a surface on which a background object and a target object are displayed. The target object is depicted in two colors such that, when viewed through a pair of color-coded anaglyph glasses by a user with both eyes, the target object appears to be 3D to the user. The background object is depicted in at least a dark color which is darker than the two colors used in depicting the target object.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example in accordance with an implementation of the present disclosure.

FIG. 2 is a diagram of an example in accordance with an implementation of the present disclosure.

FIG. 3 is a diagram of an example in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

In various implementations in accordance with the present disclosure, multiple colors may be used in forming images of one or more target objects and one or more background objects that are printed or otherwise displayed on a carrier. Accordingly, a stereoscopic 3D effect, or anaglyph 3D, may be achieved when a user views the target object(s) and/or background object(s) through a pair of color-coded anaglyph glasses. For instance, the user may wear a pair of two-color 3D glasses while looking at the target object(s) and/or background object(s) with both eyes. Advantageously, this allows the user to practice aiming at a target, or a bullseye on the target, with both eyes. That this, implementations in accordance with the present disclosure may aid trainees and enthusiast of the shooting sports in keeping both eyes open when aiming.

In some implementations in accordance with the present disclosure, each background object (not the target object(s)) may be displayed, represented or otherwise depicted in any two colors (e.g., with blue and red lines or with cyan and grey lines) to create a 3D image of the respective background object. Moreover, each target object may be displayed, represented or otherwise depicted in one or more dark colors such as black and/or dark grey.

Alternative, in some other implementations in accordance with the present disclosure, each target object (not the background object(s)) may be displayed, represented or otherwise depicted in any two colors (e.g., with blue and red lines or with cyan and grey lines) to create a 3D image of the respective background object. Moreover, each background object may be displayed, represented or otherwise depicted in one or more dark colors such as black and/or dark grey.

In some implementations in accordance with the present disclosure, the carrier on which one or more target objects and one or more background objects are printed or otherwise displayed may be a piece of paper, plate, a flat surface or a curved surface. For example, target object(s) and background object(s) may be printed on a piece of paper as a carrier. As another example, target object(s) and background object(s) may be printed or otherwise displayed on a flat or curved surface of a physical object (e.g., a wood board or clay pigeon).

### Illustrative Examples

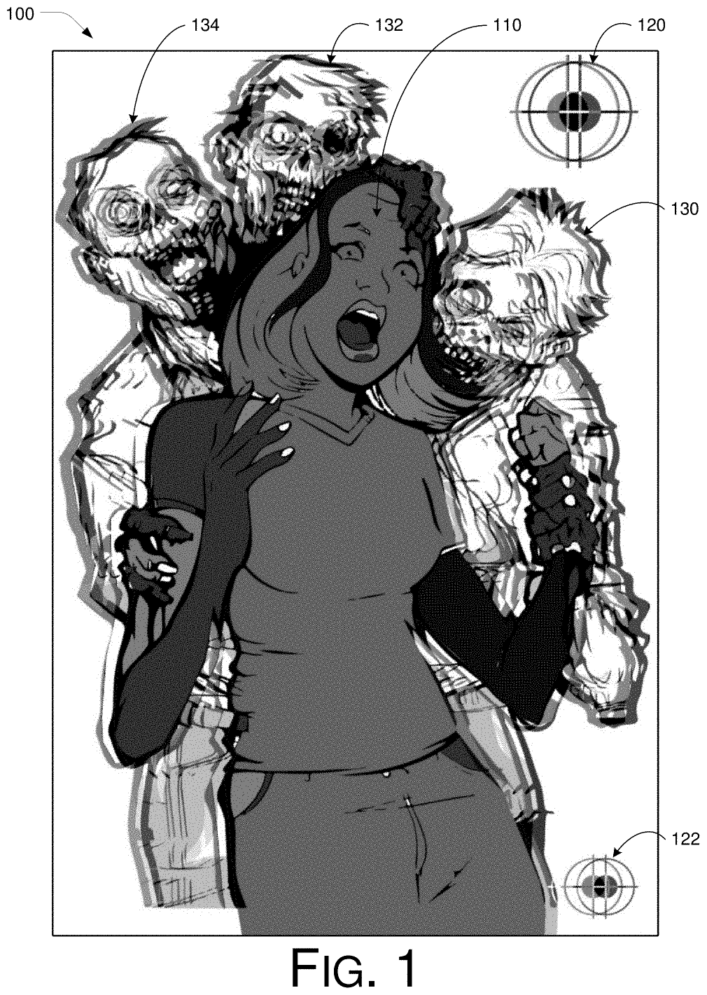

FIG. 1 illustrates an example in accordance with an implementation of the present disclosure. Referring to FIG. 1, a carrier 100, which may be a piece of paper or cardboard, has some target objects and some background objects printed thereon, including target objects 120, 122, 130, 132 and 134 as well as background object 110. Each of target objects 120, 122, 130, 132 and 134 is depicted by lines or two colors such as, for example and without limitation, blue and red, cyan and grey, grey and black, with lines of a first color representing the object itself and lines of a second color representing a shadow of the object. The shadow may be offset or shifted from the object so that, when viewed through a pair of two-color 3D glasses by a user with both eyes, the target object may appear to be 3D. The background object 110 is also depicted by lines of two colors such as, for example and without limitation, grey and black. In this example, unlike the target object(s), each background object does not have a shadow so that there is no 3D visual effect for the background object even when viewed through a pair of two-color 3D glasses.

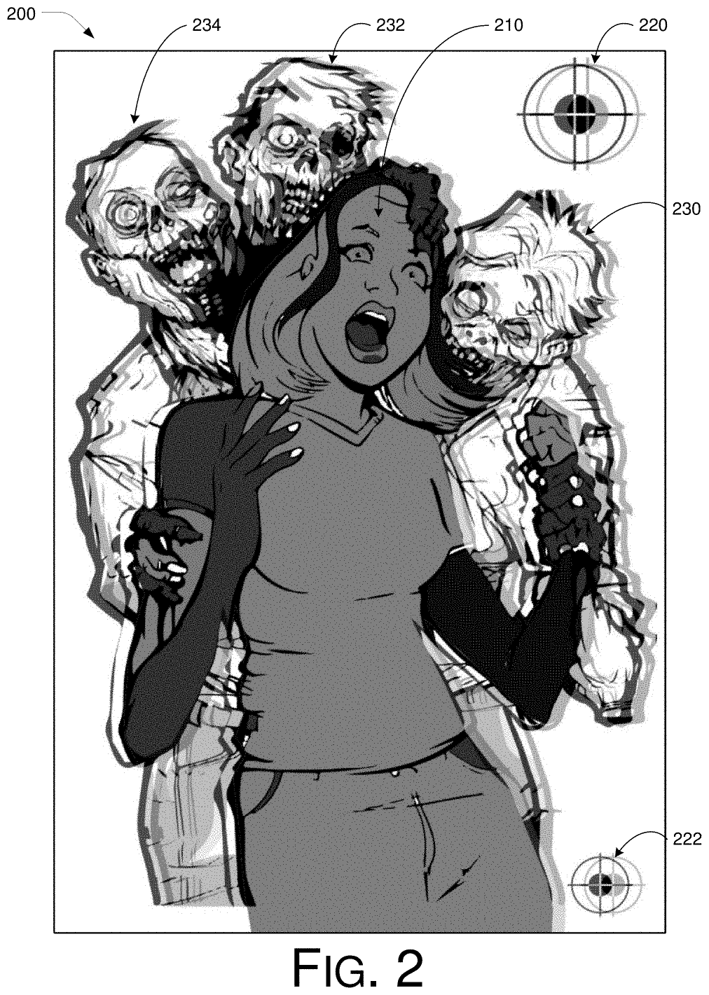

FIG. 2 illustrates an example in accordance with an implementation of the present disclosure. Referring to FIG. 2, a carrier 200, which may be a piece of paper or cardboard, has some target objects and some background objects printed thereon, including background objects 220, 222, 230, 232 and 234 as well as target object 210. Each of background objects 220, 222, 230, 232 and 234 is depicted by lines or two colors such as, for example and without limitation, blue and red, cyan and grey, grey and black, with lines of a first color representing the object itself and lines of a second color representing a shadow of the object. The shadow may be offset or shifted from the object so that, when viewed through a pair of two-color 3D glasses by a user with both eyes, the background object may appear to be 3D. The target object 210 is also depicted by lines of two colors such as, for example and without limitation, grey and black. In this example, unlike the background object(s), each target object does not have a shadow so that there is no 3D visual effect for the background object even when viewed through a pair of two-color 3D glasses.

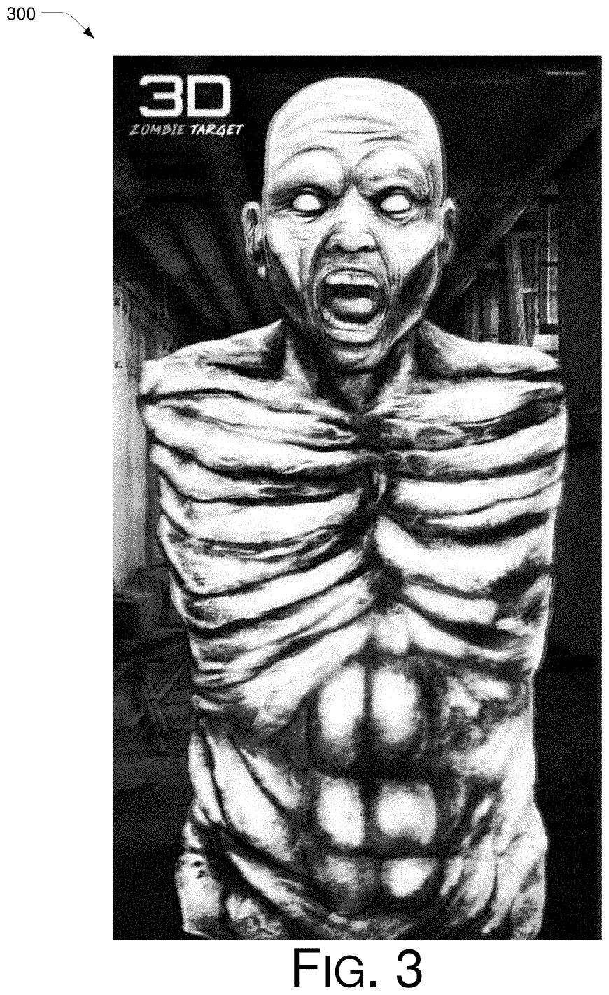

FIG. 3 illustrates an example in accordance with an implementation of the present disclosure. Referring to FIG. 3, a carrier 300, which may be a piece of paper or cardboard, has some target objects and some background objects printed thereon. In this example, a target object that resembles a zombie is printed or otherwise displayed on carrier 300, with background objects that resemble window, curtain and chair shown around and behind the zombie. In this example, the target object is depicted by lines of two colors such as, for example and without limitation, grey and black.

### Feature Highlights

In view of the above, certain features of various implementations in accordance with the present disclosure are summarized below.

In one aspect, a carrier has a surface on which a background object and a target object are displayed. The background object is depicted in two colors such that, when viewed through a pair of color-coded anaglyph glasses by a user with both eyes, the background object appears to be 3D to the user. The target object is depicted in at least a dark color which is darker than the two colors used in depicting the background object.

In some implementations, the background object may be depicted with blue and red lines.

In some implementations, the background object may be depicted with cyan and grey lines.

In some implementations, the target object may be depicted in black.

In some implementations, the target object may be depicted in dark grey.

In some implementations, the target object may be depicted in black and dark grey.

In another aspect, a carrier has a surface on which a background object and a target object are displayed. The target object is depicted in two colors such that, when viewed through a pair of color-coded anaglyph glasses by a user with both eyes, the target object appears to be 3D to the user. The background object is depicted in at least a dark color which is darker than the two colors used in depicting the target object.

In some implementations, the target object may be depicted with blue and red lines.

In some implementations, the target object may be depicted with cyan and grey lines.

In some implementations, the background object may be depicted in black.

In some implementations, the background object may be depicted in dark grey.

In some implementations, the background object may be depicted in black and dark grey.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A device, comprising:
a carrier having a surface on which a background object and a target object are displayed,
wherein:
the background object is depicted in two colors such that, when viewed through a pair of color-coded anaglyph glasses by a user with both eyes, the background object appears to be three-dimensional (3D) to the user, and
the target object is depicted in at least a dark color which is darker than the two colors.

2. The device of claim 1, wherein the background object is depicted with blue and red lines.

3. The device of claim 1, wherein the background object is depicted with cyan and grey lines.

4. The device of claim 1, wherein the target object is depicted in black.

5. The device of claim 1, wherein the target object is depicted in dark grey.

6. The device of claim 1, wherein the target object is depicted in black and dark grey.

7. A device, comprising:
a carrier having a surface on which a background object and a target object are displayed,
wherein:
the target object is depicted in two colors such that, when viewed through a pair of color-coded anaglyph glasses by a user with both eyes, the target object appears to be three-dimensional (3D) to the user, and
the background object is depicted in at least a dark color which is darker than the two colors.

8. The device of claim 7, wherein the target object is depicted with blue and red lines.

9. The device of claim 7, wherein the target object is depicted with cyan and grey lines.

10. The device of claim 7, wherein the background object is depicted in black.

11. The device of claim 7, wherein the background object is depicted in dark grey.

12. The device of claim 7, wherein the background object is depicted in black and dark grey.
